(19) United States
(12) Patent Application Publication
(10) Pub. No.: US 2006/0186099 A1
(43) Pub. Date: Aug. 24, 2006

(54) Laser cutting of thin metal workpieces with a double-focal lens

(76) Inventors: Christophe Bertez, Vaureal (FR); Karim Chouf, Levallois Perret (FR); Hakim Maazaoui, Cergy St Christophe (FR)

Correspondence Address: Elwood Haynes, Suite 1800, 2700 Post Oak Blvd., Houston, TX, 77056, US

(21) Appl. No.: 11/324,621

(22) Filed: Jan. 3, 2006

(30) Foreign Application Priority Data
Jan. 12, 2005 (FR) 0550103

(51) Int. Cl. B23K 26/06

(52) U.S. Cl. 219/121.75; 219/121.72

(57) ABSTRACT

The invention relates to a method for laser-beam cutting a metal workpiece having a thickness of less than 5 mm, in which a double focusing lens is employed making it possible to focus the laser beam at least at a first focusing point (PF1) and a second focusing point (PF2) which are separate from each other and lie on the beam axis, characterized in that the lens has a focal length (FL) of between 80 and 135 mm.

This application claims the benefit of priority under 35 U.S.C. § 119 (a) and (b) to French Application No. 0550103, filed Jan. 12, 2005, the entire contents of which are incorporated herein by reference.

### BACKGROUND

The invention relates to a method for laser-beam cutting using a lens with double focusing and with a selected focal length.

A laser cutting method conventionally employs a laser beam put out, for example, by a laser machine of the CO₂ (λ=10.6 μm) or YAG type, which beam is focused onto the workpiece to be cut by an optical element, generally a lens or a mirror of given focal length. A pressurized assisting gas is usually injected into the cutting kerf so as to remove the molten metal. The cutting kerf is then created by relative displacement, with respect to the workpiece to be cut, of the cutting head comprising the focusing element delivering the beam and delivering the assisting gas.

Transmissive focusing optics, i.e. lenses, are the elements most commonly used for laser cutting because they make it possible to create a pressurized leaktight cavity in the cutting head, where the assisting gas can be injected and then leave through a tube coaxial with the laser beam.

A focusing lens comprises two dioptres or faces, on which an antireflection treatment is deposited in order to limit losses due to reflection.

The material of the “core” of the lens is often zinc selenide for lasers of the CO₂ type and fused silica, glass (bk7), quartz or the like for lasers of the YAG type.

The various lens shapes mainly used at present are:
lanoconvex lenses composed of a spherical dioptre and a plane dioptre,
eniscus lenses composed of two spherical dioptres. This lens shape has the advantage of minimizing the spherical aberrations with respect to planoconvex lenses, and for this reason it is very widely used in laser cutting;
spherical lenses, in which the shape of the first dioptre is no longer a sphere of constant radius but is optimized so as to further reduce the geometrical aberrations with respect to a meniscus lens having spherical dioptres, and thus obtain greater power densities at the focusing point, especially in the case of focal lengths which are short i.e. less than 95.25 mm (3.75″). The output dioptre of aspherical lenses is generally plane in order to reduce their manufacturing cost.

All these lenses tend to focus the laser beam at a single focusing point of minimal diameter.

A laser cutting method using optics with a plurality of focusing points, improving the performance of the laser cutting method, is taught in particular by Document WO-A-98/14302. The shape of these optics, which are of the lens or mirror type, is such that the incident laser beam is no longer focused at a single point but at two or more focusing points, via a double-focal or multi-focal lens.

More precisely, when a double-focal lens LF is used to focus a laser beam, the part of the incident beam lying outside a diameter equal to 2H, as represented in FIG. 1, is focused at a first focal point PF1 lying at a principal focal length FL. The part of the incident laser beam L lying inside the diameter equal to 2H is in turn focused at a second focal point PF2 lying at a distance DF after the first focal point PF1 in the direction of the propagation of the light. This focusing lens LF with a double focusing point is produced with a different radius of curvature of one of the dioptres, that of the convex face for example, inside and outside the diameter 2H.

These types of focusing optics make it possible to achieve gains in speed, cutting quality and tolerance with respect to variations in the distance between the lens and the workpiece, and also make it possible to cut thicker materials than conventional lenses with a single focusing point.

Despite the teaching of this document, it has been found in practice that obtaining an efficient, high-quality cut could pose a problem for certain thicknesses.

For instance, a recurrent problem is encountered when cutting metal plates or workpieces having a thickness of less than 5 mm, preferably between 0.5 and 3 mm, for which it has been found necessary to use lenses with short focal lengths (≦130 mm) in order to obtain acceptable cutting performances.

These thicknesses are generally cut with standardized focal lengths of 127 mm (5 inches) or 95.25 mm (3.75 inches).

With longer focal lengths it is necessary to significantly slow down the cutting rates in order to obtain good cutting qualities.

### SUMMARY

It is an object of the present invention to provide a solution to this problem, i.e. to provide an efficient method for laser cutting workpieces having a thickness of less than 5 mm, preferably between 2 and 5 mm, with a double-focal lens.

The solution of the invention is a method for laser-beam cutting a metal workpiece having a thickness of less than 5 mm, in which a double focusing lens is employed making it possible to focus the laser beam at least at a first focusing point and a second focusing point which are separate from each other and lie on the beam axis, characterized in that the lens has a focal length of between 80 and 135 mm.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates a one embodiment of a laser cutting apparatus with a double focusing lens; and

FIG. 2 illustrates a graphical representation of cutting speed versus focal length for one embodiment of a laser cutting apparatus with a double focusing lens.

### DESCRIPTION OF PREFERRED EMBODIMENTS

Depending on the case, the method of the invention may comprise one or more of the following characteristics:
the lens has a focal length of between 90 and 130 mm, preferably of at least 100 mm;
the lens has a focal length equal to 127 mm;
the lens has a central part of diameter having a first radius of curvature for focusing the first focusing point at the focal length, the said diameter being less than 20 mm;
the diameter of the lens is between 4 and 15 mm;
a workpiece having a thickness lying between 1 and 4 mm is cut;
the distance between the two focusing points is between 1 and 12 mm;
the distance between the two focusing points is between 3 and 5 mm;
the metal workpiece is made of stainless steel, soft steel, aluminium or aluminium alloy, titanium or titanium alloy, copper or copper alloy;
an assisting gas containing nitrogen is used;
the laser beam has a power of between 0.5 and 15 kW, preferably between 1 kW and 6 kW;
the laser beam is emitted by a laser device of the CO₂ type.

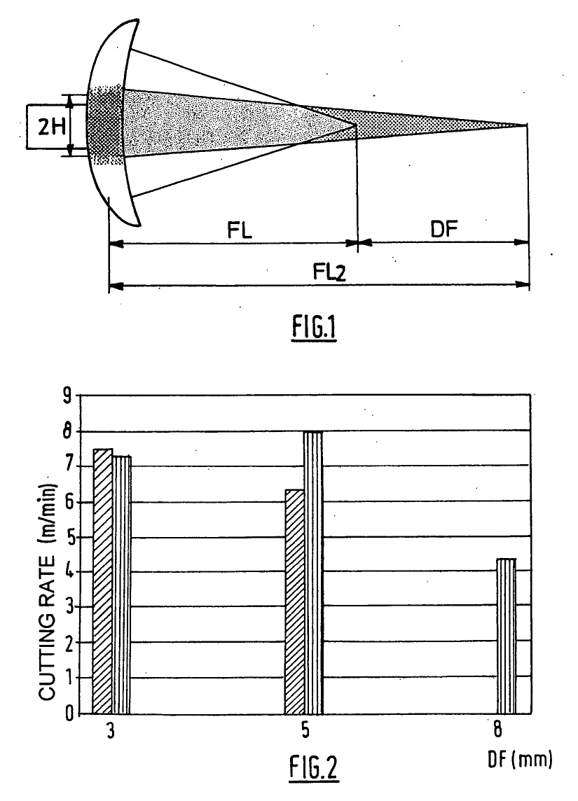

Within the context of the present invention, it has been shown that the laser cutting process with a double-focal lens is conditioned by the parameters of the lens being used, i.e. its focal length FL, its 2H and its 2F, as represented in FIG. 1.

The diameter 2H of the lens corresponds to the diameter of the part lying at the centre of the lens, having a radius of curvature different from that of the peripheral exterior part of the lens. The part of the incident beam lying outside the diameter 2H is focused at a first focal point PF1 lying at a principal focal length FL. The part of the incident laser beam lying inside the diameter 2H is focused at a second focal point PF2 lying at a principal focal length FL2.

The size of the diameter 2H determines the amount of energy focused at the second focusing point PF2.

The distance DF in turn corresponds to the difference between the focal lengths FL and FL2, as shown in FIG. 1.

### EXAMPLE

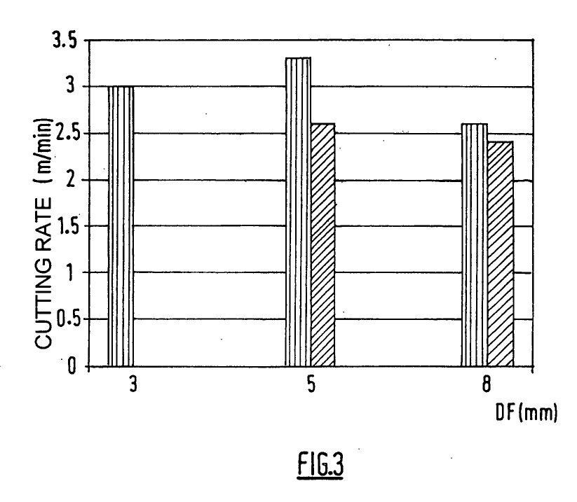

Tests carried out on stainless steel workpieces with thicknesses of 2 mm and 4 mm, the results of which are respectively represented in FIGS. 2 and 3, confirm that for thicknesses of less than 5 mm, that is to say generally between 1 and 4 mm, it is desirable to use a lens of focal length FL=127 mm which also has values of 2H lying between 4 mm and 15 mm.

The value of the diameter 2H in these trials is 8 mm, the laser power is 4 kW and the assisting gas is nitrogen.

Furthermore, in these tests, the results were obtained for pressures of 15 bar or 16 bar (grey bars in FIGS. 2 and 3 respectively) and 19 bar (black bars in FIGS. 2 and 3) by using a double-focal lens in all cases.

For the focal length FL=127 mm and the above values of 2H, the best laser cutting performances were obtained for values of DF lying between 3 and 5 mm, as can be seen in these FIGS. 2 and 3.

This is because, for these values of FL, 2H and DF, the energy distribution of laser energy absorbed in the cutting kerf becomes optimal. Furthermore, the width of the kerf becomes sufficient to allow good penetration of the gas and optimal removal of the molten metal.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for laser-beam cutting a metal workpiece having a thickness of less than 5 mm, in which a double focusing lens is employed making it possible to focus the laser beam at least at a first focusing point (PF1) and a second focusing point (PF2) which are separate from each other and lie on the beam axis, characterized in that the lens has a focal length (FL) of between 80 and 135 mm.

2. The method according to claim 1, characterized in that the lens has a focal length (FL) of between 90 and 130 mm, preferably of at least 100 mm.

3. The method according to claim 1, characterized in that the lens has a focal length (FL) equal to 127 mm.

4. The method according to claim 1, characterized in that the lens has a central part of diameter (2H) having a first radius of curvature for focusing the first focusing point (PF1) at the focal length (FL), the said diameter (2H) being less than 20 mm.

5. The method according to claim 4, characterized in that the diameter (2H) of the lens is between 4 and 15 mm.

6. The method according to claim 1, characterized in that a workpiece having a thickness lying between 1 and 4 mm is cut.

7. The method according to claim 1, characterized in that the distance (PF) between the two focusing points (PF1, PF2) is between 1 and 12 mm.

8. The method according to claim 7, characterized in that the distance (PF) between the two focusing points (PF1, PF2) is between 3 and 5 mm.

9. The method according to claim 1, characterized in that the metal workpiece is made of stainless steel, soft steel, aluminium or aluminium alloy, titanium or titanium alloy, copper or copper alloy.

10. The method according to claim 1, characterized in that an assisting gas containing nitrogen is used.

11. The method according to claim 1, characterized in that the laser beam has a power of between 0.5 and 15 kW, preferably between 1 kW and 6 kW.

12. The method according to claim 1, characterized in that the laser beam is emitted by a laser device of the CO₂ type.
